(19) United States
(12) Patent Application Publication
(10) Pub. No.: US 2024/0250873 A1
(43) Pub. Date: Jul. 25, 2024

(54) ADJUSTMENT OF TRANSMISSION SCHEDULING HIERARCHY

(71) Applicant: Intel Corporation, Santa Clara, CA (US)

(72) Inventors: Benjamin H. SHELTON, Eugene, OR (US); Erik G. CARRILLO, Austin, TX (US)

(21) Appl. No.: 18/627,886

(22) Filed: Apr. 5, 2024

Related U.S. Application Data
(60) Provisional application No. 63/611,112, filed on Dec. 15, 2023.

(51) Int. Cl. H04L 41/0813; H04L 41/122

(52) U.S. Cl. CPC H04L 41/0813; H04L 41/122

(57) ABSTRACT

Examples described herein relate to network interface device configured to adjust a first configuration of a first packet transmission scheduling hierarchy associated with a virtual function (VF) to a second configuration of a second transmission scheduling hierarchy for the VF. The Configuring the network interface device to utilize the second configuration for the VF can be delayed until occurrence of a trigger event.

### RELATED APPLICATION

This application claims priority from U.S. Provisional Application No. 63/611,112, filed Dec. 15, 2023. The entire content of that application is incorporated by reference in its entirety.

### BACKGROUND

A network interface controller (NIC) utilizes a configurable hardware transmit (Tx) scheduler to pace transmission of packets from queues. The Tx scheduler implements a multi-level quality of service (QOS) scheduling tree with arbitration and shaping at a node, with a subhierarchy for a physical egress NIC port. Configuring Tx scheduler operations can include adding nodes, removing nodes, adjusting existing nodes' parameters, moving nodes and subtrees, binding nodes to congestion domains, or others. Configuring Tx scheduler operations can occur by writing commands to firmware (FW) of the NIC, which sets up the Tx scheduler hardware tables in the NIC.

### BRIEF DESCRIPTION OF THE DRAWINGS

FIG. 1 depicts an example system.

FIG. 2 depicts an example process.

FIG. 3 depicts an example process.

FIG. 4 depicts an example network interface device.

FIG. 5 depicts example network interface device.

FIG. 6 depicts an example system.

### DETAILED DESCRIPTION

A Tx scheduler can be allocated to a physical function (PF) and virtual function (VF) Virtual Station Interfaces (VSIs) in the system. In some cases, after configuration of a Tx scheduler topology for a VF, reconfiguration of the scheduler topology may not take place while the VF is active. For example, Intel® Adaptable Virtual Function (IAVF) kernel and user space drivers can be used for configuring Tx QoS for the Tx queues associated with the VFs. The VF-PF communication protocol used on IAVF (e.g., virtchnl) configures a VF's Tx queues and receive (Rx) queues after the VF becomes active, but may not allow reconfiguration of the scheduler topology.

An orchestration application can configure the Tx scheduler for NIC VFs, which can then be mapped to a VF associated with a process (e.g., virtual machine (VM), container, application, or others) and accessed by a driver (e.g., a Linux kernel space driver or Data Plane Development Kit (DPDK) user space driver). Various examples provide for configuration of a Tx scheduler topology for a VF while permitting utilization of the active Tx scheduler topology for egressed packet traffic. Configuration of the Tx scheduler topology can adjust transmit queue packet traffic shaping and transmission QoS to change default rate limit per-queue and for group of queues. Various examples provide a checkpoint-based system for configuring packet transmission QoS for a NIC VF. For example, a NIC PF driver can store a Tx scheduler topology and based on reaching a checkpoint or trigger, the driver can issue a VF reset. While the VF is inactive during reset, the driver can copy the Tx scheduler topology to the NIC. Based on activation of the VF from reinitialization of the VF after the reset, the VF's Tx queue hierarchy can be updated with the Tx scheduler topology copied to the NIC.

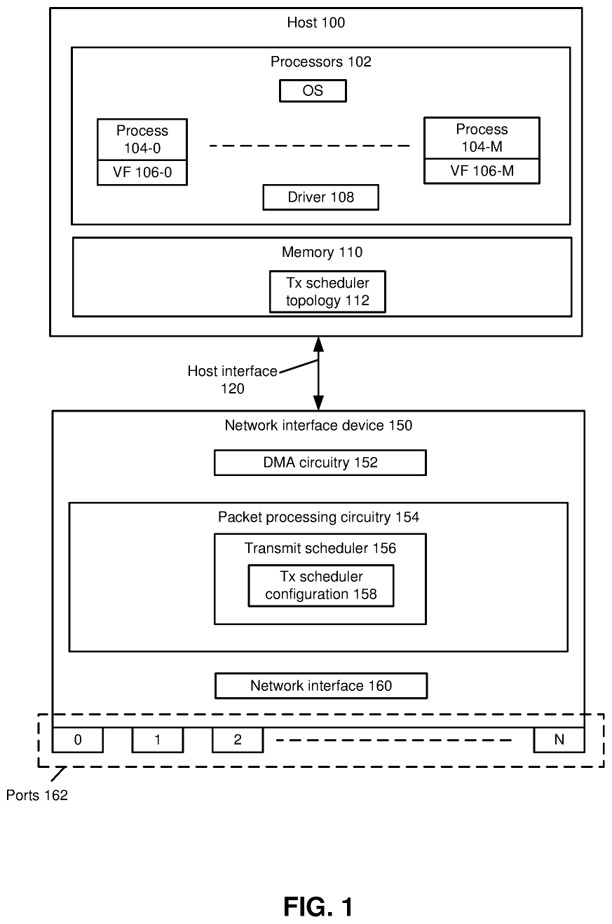

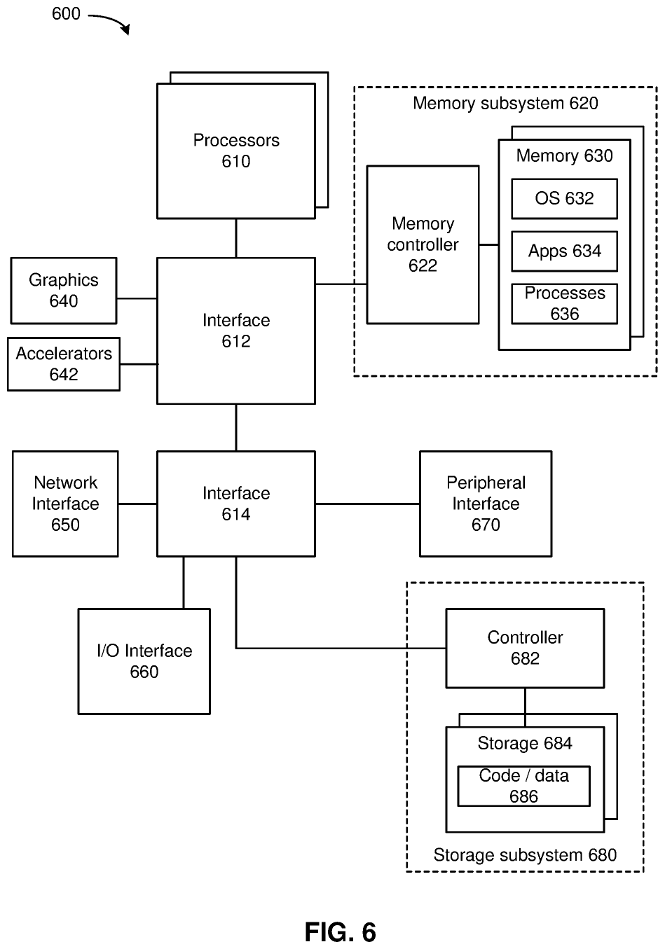

FIG. 1 depicts an example system. Host 100 can include circuitry and/or software described at least with respect to FIG. 6. Host 100 can include one or more processors 102 (e.g., a central processing unit (CPU); a programmable packet processing circuitry; an accelerator; an application specific integrated circuit (ASIC); a field programmable gate array (FPGA); a graphics processing unit (GPU); a memory device; or other circuitry). One or more processors 102 can execute one or more of processes 104-0 to 104-M (where M is an integer), a driver, and an operating system (OS). Processes 104-0 to 104-M can include one or more of: an application, a microservice, virtual machine (VM), microVM, container, thread, or other virtualized execution environment.

One or more of processes 104-0 to 104-M can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments (e.g., virtual machine (VM), microVM, microservice, container, or others). VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. A process can perform video processing or media transcoding (e.g., changing the encoding of audio, image or video files).

In some examples, processes 104-0 to 104-M or other circuitry in host 100 can access network interface device 150 as one or more virtualized devices by an associated virtual function (VF) 106-0 to 106-M. A VF can be associated with a tenant running in a multi-tenant environment.

Host 100 and network interface device 150 can be communicatively coupled by host interface 120. Host interface 120 can provide communication using one or more of the following protocols: Improved Inter Integrated Circuit (I3C), Universal Serial Bus Type-C (USB-C), serial peripheral interface (SPI), enhanced SPI (eSPI), System Management Bus (SMBus), I2C, MIPI I3C®, Peripheral Component Interconnect Express (PCIe), Compute Express Link (CXL). See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof.

For example, processes 104-0 to 104-M or other circuitry in host 100 can access network interface device 150 using virtualization technologies described herein. Single Root I/O Virtualization (SR-IOV) and Sharing specification, version 1.1, published Jan. 20, 2010 specifies hardware-assisted performance input/output (I/O) virtualization and sharing of devices. SR-IOV can provide a device partitioning to create multiple virtual functions (VFs) on a physical function (PF). Intel® Scalable I/O Virtualization (SIOV) permits configuration of a device to group its resources into multiple isolated Assignable Device Interfaces (ADIs). Direct Memory Access (DMA) transfers from/to an ADI are tagged with a unique Process Address Space identifier (PASID) number. SIOV enables software to flexibly compose virtual devices utilizing the hardware-assists for device sharing. An example technical specification for SIOV is Intel® Scalable I/O Virtualization Technical Specification, revision 1.0, June 2018, as well as earlier versions, later versions, and variations thereof.

Network interface device 150 can be implemented as one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth).

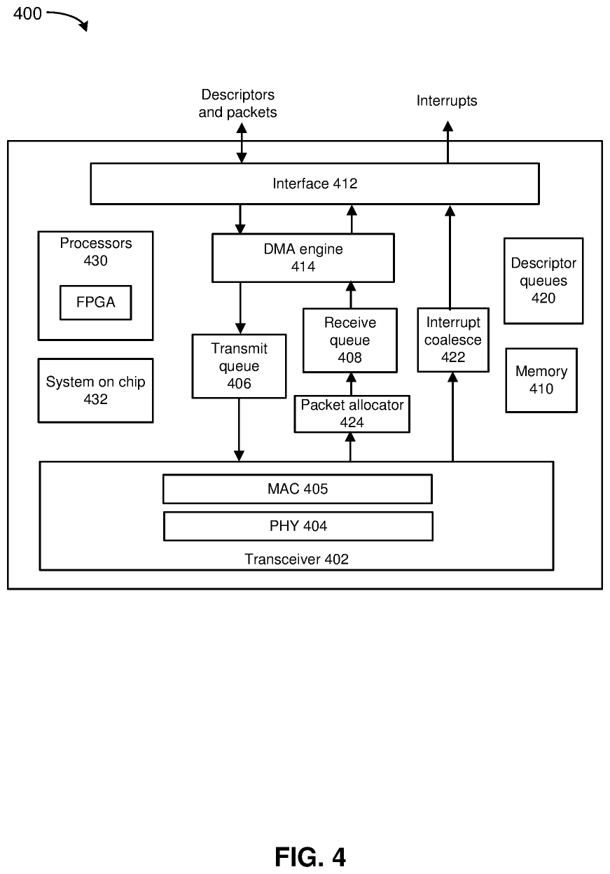

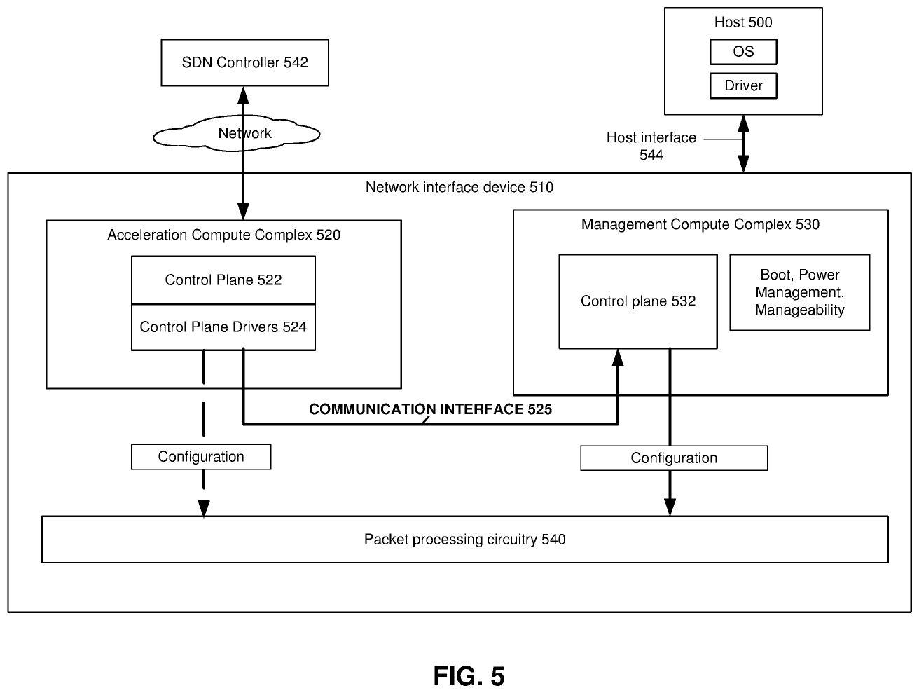

Network interface device 150 can include at least a direct memory access (DMA) circuitry 152, packet processing circuitry 154, and network interface 160, as well as other circuitry and software described with respect to FIGS. 4, 5, and/or 6.

Direct memory access (DMA) circuitry 152 can allow an input/output (I/O) device to bypass a central processing unit (CPU) or core, and to send or receive data directly to or from a system memory. Because DMA allows the CPU or core to not manage a copy operation when sending or receiving data to or from the system memory, the CPU or core can be available to perform other operations. Without DMA, when the CPU or core is using programmed input/output, the CPU or core is typically occupied for the entire duration of a read or write operation and is unavailable to perform other work. With DMA, the CPU or core can, for example, initiate a data transfer, and then perform other operations while the data transfer is in progress. A CPU or core can receive an interrupt from a DMA controller when the data transfer is finished. Some examples of DMA circuitry 152 provide data mover and transformation operations. For example, DMA circuitry 152 can validate cyclic redundancy check (CRC) or checksum values in connection with copying of data for storage and networking applications.

Network interface 160 can include a media access control (MAC) processor, physical layer interface (PHY), or other circuitries described with respect to FIGS. 4, 5, and/or 6. Network interface device 150 can utilize one or more of ports 162-0 to 162-N (where N is an integer) to receive packets (at ingress) or transmit packets (at egress).

For example, an orchestrator or data center administrator can specify a Tx scheduler topology 112 for a process or a VF and store Tx scheduler topology 112 into memory 110 via an application programming interface (API) or configuration file. In some examples, a processor-executed driver 108 for network interface device 150 can configure packet transmission scheduling hierarchy 158 for a tenant's process (e.g., one or more of process 104-0 to 104-M) or a VF (e.g., one or more of VF 106-0 to 106-M) by causing a trigger event. Based on reaching the trigger event (e.g., reset of an individual VF that is to apply Tx scheduler topology 112), driver 108 can copy Tx scheduler topology 112 to memory accessible to packet processing circuitry 154 of network interface device 150. Based on reinitialization or reset of the VF after the reset, the VF's Tx queue hierarchy 158 can be updated with the copied Tx scheduler topology 112 from memory 110. Transmit scheduler 156 can apply Tx scheduler topology 112 to schedule transmission of packets via one or more of ports 162-0 to 162-N. Driver 108 can manage the checkpointing and the state machine and to expose a userspace interface allowing for centralized configuration of the VFs.

In some examples, a VF can be reset based at least on: update a topology, load a driver (e.g., Linux kernel driver or DPDK userspace driver) on the VF to put the VF into a known state from which the VF driver can initialize, the VF driver has requested new or different resources to be mapped into the VF (e.g., increasing the number of Tx/receive (Rx) queues from a default level) so that the updated set of resources are mapped to the VF after VF reset, host 100 or network interface device 150 has reset, or others.

Driver 108 can include a kernel driver that provides inter-driver communication (IDC) between a bus owner and traffic shaper driver. The traffic shaper driver can control packet transmit queues by allowing a process, orchestrator, or administrator to configure rate limits for queues in Tx scheduler topology 112. For example, a DPDK Device Specific Interface (DSI) or other application programming interface (API) can be used to configure rate limits for queues or configure Tx QoS for local area network (LAN) VFs. For example, driver 108 can include Intel® Adaptable Virtual Function (IAVF) kernel and user space drivers. Driver 108 can execute on host 100 and/or network interface device 150.

The traffic shaper driver can create a Tx scheduler subhierarchy configuration 158 for one or more VFs. A process, orchestrator, or administrator may manipulate the subhierarchy, or call an API to clear the subhierarchy for a given VF. Based on the process, orchestrator, or administrator calling an API to remove a local area network (LAN) VF node, the node can be marked in the traffic shaper driver's software database (SW DB) in Tx scheduler topology 112 with a flag indicating that the node is to be deleted after checkpoint commit. Based on the process, orchestrator, or administrator calling an API to add a LAN VF node, the node can be created in the SW DB but marked with a flag indicating that the node is to be created in network interface device 150 after a checkpoint commit. In some examples, scheduler tree updates that do not involve a topology change (e.g., adjusting a node's priority or weight or suspending or resuming a node) can take place at VF runtime without a checkpoint commit and VF reset.

Based on a process, administrator, orchestrator application calling an API to commit a checkpoint for a VF, traffic shaper driver 108 can issue a VF reset for the specified VF. Based on the VF being inactive for a reset, traffic shaper driver 108 can traverse the VF's subtree in the SW DB and remove VF node(s) from a scheduler tree configuration 158 of network interface device 150. Based on the VF reset completing, traffic shaper driver 108 can traverse the VF's subtree in the SW DB in Tx scheduler topology 112 and add the appropriate node(s) to the scheduler tree configuration 158 of network interface device 150, including nodes that were marked for creation after checkpoint commit, but not including nodes that were marked for deletion after checkpoint commit. At this point, the configured Tx scheduler state in Tx scheduler configuration 158 for the VF's subtree matches that in the SW DB. Traffic shaper driver 108 can update the SW DB so that Tx scheduler subhierarchy 112 in the SW DB matches the Tx scheduler subhierarchy 158 applied by network interface device 150 by unmarking nodes that were marked for creation after checkpoint commit, and removing nodes from the SW DB that were marked for deletion after checkpoint commit. If update of the Tx scheduler subhierarchy 158 fails, network interface device 150 can roll back to the last committed checkpoint subhierarchy, as preserved in the SW DB in memory 110.

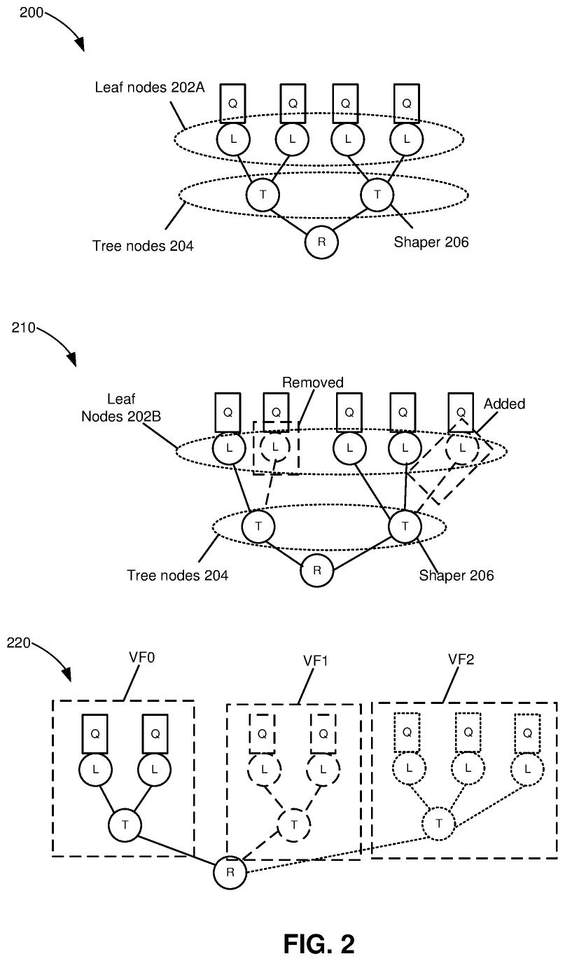

FIG. 2 depicts an example of transmit scheduler topology adjustment. Changing a transmission scheduling hierarchy can include adjusting a number or arrangement of transmit queues and leaf nodes, tree nodes, and/or a root node. Configuration 200 can represent a Tx scheduler topology applied by a network interface device. Leaf nodes 202A can receive packets from transmit queues (Q) that provide packets. Leaf nodes 202A can apply arbitration and traffic shaping by transmit rate limiting and bandwidth allocation based on priority level, including best efforts for no priority level or low priority level traffic. Shaping can attempt to limit traffic transmission peak rates from queues to limit spikes above a service level agreement (SLA)-contracted rate by buffering or delaying packet traffic to transmit until transmit bandwidth is available. Tree nodes 204 can apply weighting for allowing traffic from leaf nodes 202A to be at or below an allocated bandwidth level for a particular VF. Root node R can limit a peak rate that can be egressed from a physical port.

Configuration 210 can represent a second Tx scheduler topology to be applied by the network interface device. Among leaf nodes 202B, a leaf node marked as removed can be removed when the second Tx scheduler topology is applied by the network interface device. Among leaf nodes 202B, a leaf node marked as added can be added when the second Tx scheduler topology is applied by the network interface device.

Configuration 220 depicts an example topology where different queue and leaf nodes and tree nodes are associated with different VFs (VF0 to VF2). The topologies for different VFs supply packets that are rate limited by a root node R.

In some examples, changes in rate limiting and arbitration of a shaper and arbitrator node 204 can be updated by a call to an application programming interface (API) without waiting for a checkpoint commit. Rate limiting can refer to a peak rate of transmission of packets associated with a particular flow or queue or priority level. Arbitration can refer to a weighting of transmission bandwidth allocated to multiple queues or a manner of selection of a packet from a queue (e.g., round robin, weighted round robin, preemptive priority, or a combination of these and other policies). For example, if weighting or shaping of a leaf or tree node changes without a topology change (e.g., add node, remove node, or move node), such weighting or shaping of a leaf or tree node changes can be applied without resetting a VF and while the Tx scheduler topology is operational.

A packet may be used herein to refer to various formatted collections of bits that may be sent across a network, such as Ethernet frames, IP packets, TCP segments, UDP datagrams, etc.

A flow can be a sequence of packets being transferred between two endpoints, generally representing a single session using a known protocol. Accordingly, a flow can be identified by a set of defined tuples or header field values and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Reference to flows can instead or in addition refer to tunnels (e.g., Multiprotocol Label Switching (MPLS) Label Distribution Protocol (LDP), Segment Routing over IPv6 dataplane (SRv6) source routing, VXLAN tunneled traffic, GENEVE tunneled traffic, virtual local area network (VLAN)-based network slices, technologies described in Mudigonda, Jayaram, et al., “Spain: Cots data-center ethernet for multipathing over arbitrary topologies,” NSDI. Vol. 10. 2010 (hereafter “SPAIN”), and so forth.

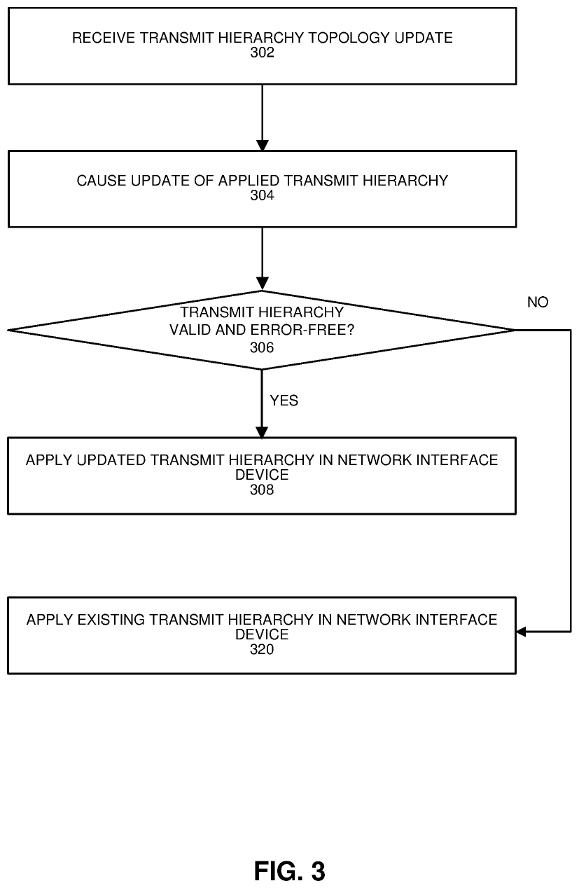

FIG. 3 depicts an example process. The process can be performed by a device driver and/or network interface device. At 302, a new or modified Tx scheduler topology can be stored in memory of a host system or in a memory of a network interface device. For example, an administrator or orchestrator can provide the new or modified Tx scheduler topology into the memory of a host system or in the memory of a network interface device via a device interface or one or more packets.

At 304, based on a trigger event such as a reset of a VF that is to apply the new or modified Tx scheduler topology, a driver can cause the new or modified Tx scheduler topology to be set as a Tx scheduler topology configuration for the network interface device. For example, the driver can cause the new or modified Tx scheduler topology to be copied from the memory of the host system or the memory of the network interface device to a region of memory in the network interface device that the network interface device utilizes to schedule packet transmissions. An orchestrator can request committing the new or modified Tx scheduler topology for performance by the network interface device.

At 306, validation of the new or modified Tx scheduler topology configuration can occur. For example, the new or modified Tx scheduler topology Tx scheduler topology configuration can be valid if leaf nodes are connected to queues, leaf nodes are connected to tree nodes, tree nodes are connected to a root node, and/or node or shaper limits are not exceeded. For example, the new or modified Tx scheduler topology Tx scheduler topology configuration can be invalid or include an error due to inability to accommodate topology in the network interface device or firmware or hardware bugs associated with the new or modified Tx scheduler topology configuration being detected. Based on the new or modified Tx scheduler topology being valid, the process can proceed to 308. Based on the new or modified Tx scheduler topology being invalid, the process can proceed to 320.

At 308, the new or modified Tx scheduler topology can be loaded on to the network interface device for utilization. For example, a VF associated with the new or modified Tx scheduler topology can be reset, the VF's existing scheduler topology can be removed or modified so that the new or modified Tx scheduler topology is loaded on the network interface device, and the VF activated to apply the new or modified Tx scheduler topology.

At 320, based on failure to validate or commit the new or modified Tx scheduler topology or an error in the new or modified Tx scheduler topology, the network interface device can rollback or continue to apply the existing Tx scheduler topology for the VF. An error in the new or modified Tx scheduler topology can occur based on failure to map the new or modified Tx scheduler topology onto hardware resources or an internal firmware error (e.g., bug in firmware triggered by new or modified Tx scheduler topology). The new or modified Tx scheduler topology can remain stored in memory of a host system or in a memory of a network interface device so the orchestrator can adjust checkpointed topology and attempt to re-commit the new or modified Tx scheduler topology can be stored in memory of a host system or in a memory of a network interface device.

FIG. 4 depicts an example network interface device. In some examples, processors 404 and/or FPGAs 430 can be configured to adjust a packet transmission scheduling hierarchy, as described herein. Some examples of network interface 400 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 400 can include transceiver 402, processors 404, transmit queue 406, receive queue 408, memory 410, and bus interface 412, and DMA engine 414. Transceiver 402 can be capable of receiving and transmitting packets in conformance with the applicable protocols such as Ethernet as described in IEEE 802.3, although other protocols may be used. Transceiver 402 can receive and transmit packets from and to a network via a network medium (not depicted). Transceiver 402 can include PHY circuitry 404 and media access control (MAC) circuitry 405. PHY circuitry 404 can include encoding and decoding circuitry (not shown) to encode and decode data packets according to applicable physical layer specifications or standards. MAC circuitry 405 can be configured to perform MAC address filtering on received packets, process MAC headers of received packets by verifying data integrity, remove preambles and padding, and provide packet content for processing by higher layers. MAC circuitry 405 can be configured to assemble data to be transmitted into packets, that include destination and source addresses along with network control information and error detection hash values.

Processors 430 can be one or more of: combination of: a processor, core, graphics processing unit (GPU), field programmable gate array (FPGA), application specific integrated circuit (ASIC), or other programmable hardware device that allow programming of network interface 400. For example, a “smart network interface” or SmartNIC can provide packet processing capabilities in the network interface using processors 430.

Processors 430 can include a programmable processing pipeline or offload circuitries that is programmable by P4, Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be utilized for packet processing or packet modification. Ternary content-addressable memory (TCAM) can be used for parallel match-action or look-up operations on packet header content. Processors 430 can be configured to adjust a packet transmission scheduling hierarchy, as described herein.

Packet allocator 424 can provide distribution of received packets for processing by multiple CPUs or cores using receive side scaling (RSS). When packet allocator 424 uses RSS, packet allocator 424 can calculate a hash or make another determination based on contents of a received packet to determine which CPU or core is to process a packet.

Interrupt coalesce 422 can perform interrupt moderation whereby interrupt coalesce 422 waits for multiple packets to arrive, or for a time-out to expire, before generating an interrupt to host system to process received packet(s). Receive Segment Coalescing (RSC) can be performed by network interface 400 whereby portions of incoming packets are combined. Network interface 400 provides this coalesced packet to an application.

Direct memory access (DMA) engine 452 can copy a packet header, packet payload, and/or descriptor directly from host memory to the network interface or vice versa, instead of copying the packet to an intermediate buffer at the host and then using another copy operation from the intermediate buffer to the destination buffer.

Memory 410 can be volatile and/or non-volatile memory device and can store any queue or instructions used to program network interface 400. Transmit traffic manager can schedule transmission of packets from transmit queue 406. Transmit queue 406 can include data or references to data for transmission by network interface. Receive queue 408 can include data or references to data that was received by network interface from a network. Descriptor queues 420 can include descriptors that reference data or packets in transmit queue 406 or receive queue 408. Bus interface 412 can provide an interface with host device (not depicted). For example, bus interface 412 can be compatible with or based at least in part on PCI, PCIe, PCI-x, Serial ATA, and/or USB (although other interconnection standards may be used), or proprietary variations thereof.

FIG. 5 depicts an example network interface device. Host 500 can include processors, memory devices, device interfaces, as well as other circuitry such as described herein. Processors of host 500 can execute software such as applications (e.g., microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes.

Packet processing device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to herein. Similarly, MCC 530 can be implemented as one or more of: a microprocessor, processor, accelerator, field programmable gate array (FPGA), application specific integrated circuit (ASIC) or circuitry described herein. In some examples, ACC 520 and MCC 530 can be implemented as separate cores in a CPU, different cores in different CPUs, different processors in a same integrated circuit, different processors in different integrated circuit.

Packet processing device 510 can be implemented as one or more of: a microprocessor, processor, accelerator, field programmable gate array (FPGA), application specific integrated circuit (ASIC) or circuitry described herein. Packet processing pipeline circuitry 540 can process packets as directed or configured by one or more control planes executed by multiple compute complexes. In some examples, ACC 520 and MCC 530 can execute respective control planes 522 and 532.

Packet processing device 510, ACC 520, and/or MCC 530 can be configured to adjust a packet transmission scheduling hierarchy, as described herein.

SDN controller 542 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 542 to configure operation of packet processing pipeline 540. Control plane application 522 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 542 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 542 can provide packet processing rules for performance by ACC 520. For example, ACC 520 can program table rules (e.g., header field match and corresponding action) applied by packet processing pipeline circuitry 540 based on change in policy and changes in VMs, containers, microservices, applications, or other processes. ACC 520 can be configured to provide network policy as flow cache rules into a table to configure operation of packet processing pipeline 540. For example, the ACC-executed control plane application 522 can configure rule tables applied by packet processing pipeline circuitry 540 with rules to define a traffic destination based on packet type and content. ACC 520 can program table rules (e.g., match-action) into memory accessible to packet processing pipeline circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing pipeline circuitry 540 as to which VM is to receive traffic and what kind of traffic a VM can transmit. For example, packet processing pipeline circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to Baseboard Management Controller (BMC), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing pipeline circuitry 540 or other processors to perform operations related to NVMe, NVMe-OF reads or writes, lookaside crypto Engine (LCE), Address Translation Engine (ATE), local area network (LAN), compression/decompression, encryption/decryption, or other accelerated operations.

Various message formats can be used to configure ACC 520 or MCC 530. In some examples, MCC 530 can configure packet processing circuitry 540 to adjust a packet transmission scheduling hierarchy, as described herein. Operation of packet processing circuitry 540, including its data plane, can be programmed using P4, C, Python, Broadcom Network Programming Language (NPL), or x86 compatible executable binaries or other executable binaries.

FIG. 6 depicts a system. In some examples, circuitry of system 600 can configure network interface device 650 to adjust a packet transmission scheduling hierarchy, as described herein. In some examples, circuitry of network interface device 650 can be utilized to adjust a packet transmission scheduling hierarchy, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 632, a system administrator, and/or orchestrator can enable or disable network interface 650 to adjust a packet transmission scheduling hierarchy, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.””

Illustrative examples of the devices, systems, and methods disclosed herein are provided below. An embodiment of the devices, systems, and methods may include any one or more, and any combination of, the examples described below.
Example 1 includes one or more examples and at least one non-transitory computer-readable medium comprising instructions stored thereon, that if executed by one or more processors, cause the one or more processors to: execute a network interface device driver that is to: adjust a first configuration of a first packet transmission scheduling hierarchy associated with a virtual function (VF) to a second configuration of a second transmission scheduling hierarchy for the VF and delay configuring the network interface device to utilize the second configuration for the VF until a trigger event.
Example 2 includes one or more examples, wherein the trigger event comprises reset of the VF.
Example 3 includes one or more examples, wherein the configure the network interface device to utilize the second configuration for the VF based on the trigger event is also based on the second configuration being valid.
Example 4 includes one or more examples, wherein the configure the network interface device to utilize the second configuration for the VF based on the trigger event comprises: reset the VF; cause the network interface device to apply the second configuration for the VF; and commence VF initialization.
Example 5 includes one or more examples, comprising instructions stored thereon, that if executed by the one or more processors, cause the one or more processors to: execute the device driver to revert to the first configuration for the VF based on an error in the second configuration.
Example 6 includes one or more examples, wherein the network interface device driver is to access the network interface device in a manner consistent with Single Root I/O Virtualization (SR-IOV) or Scalable I/O Virtualization (SIOV).
Example 7 includes one or more examples, and includes a method comprising: configuring packet transmission scheduling for a Network Interface Controller (NIC) Virtual Function (VF) by: while the NIC applies a first transmission scheduling configuration, a NIC Physical Function (PF) device driver storing a second transmission scheduling configuration and based on a trigger event, propagating the second transmission scheduling configuration to the NIC.
Example 8 includes one or more examples, comprising: based on the second transmission scheduling configuration being valid, the NIC applying the second transmission scheduling configuration.
Example 9 includes one or more examples, wherein the trigger event comprises reset of the VF and wherein the PF driver performs the propagating the second transmission scheduling configuration to the NIC.
Example 10 includes one or more examples, wherein the second transmission scheduling configuration comprises a packet transmission scheduling topology.
Example 11 includes one or more examples, wherein the propagating the second transmission scheduling configuration to the NIC changes a packet transmission scheduling hierarchy.
Example 12 includes one or more examples, and includes: propagating a third transmission scheduling configuration to the NIC based on the third transmission scheduling configuration changing a weighting or shaping configuration of a leaf node or a tree node without a topology change to the second transmission scheduling configuration.
Example 13 includes one or more examples, and includes: based on the second transmission scheduling configuration being invalid or including an error, applying the first transmission scheduling configuration.
Example 14 includes one or more examples, and includes: an apparatus that includes: a network interface device comprising: a direct memory access (DMA) circuitry; a host interface; a network interface; and circuitry configured to: apply a first packet transmission scheduling configuration for a virtual function (VF) and based on a trigger event, apply a second packet transmission scheduling configuration.
Example 15 includes one or more examples, wherein the circuitry is to: apply the second packet transmission scheduling configuration based on the trigger event and the second packet transmission scheduling configuration being valid.
Example 16 includes one or more examples, wherein the trigger event comprises reset of the VF.
Example 17 includes one or more examples, wherein the first and second packet transmission scheduling configurations comprise packet transmission scheduling topologies.
Example 18 includes one or more examples, wherein the circuitry is to adjust a scheduling or arbitration property of the first packet transmission scheduling configuration independent from occurrence of the trigger event.
Example 19 includes one or more examples, wherein the VF is consistent with Single Root I/O Virtualization (SR-IOV) or Scalable I/O Virtualization (SIOV).
Example 20 includes one or more examples, wherein the network interface device comprises one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU).

1. At least one non-transitory computer-readable medium comprising instructions stored thereon, that if executed by one or more processors, cause the one or more processors to:
execute a network interface device driver that is to:
adjust a first configuration of a first packet transmission scheduling hierarchy associated with a virtual function (VF) to a second configuration of a second transmission scheduling hierarchy for the VF and
delay configuring the network interface device to utilize the second configuration for the VF until a trigger event.

2. The at least one computer-readable medium of claim 1, wherein the trigger event comprises reset of the VF.

3. The at least one computer-readable medium of claim 1, wherein the configure the network interface device to utilize the second configuration for the VF based on the trigger event is also based on the second configuration being valid.

4. The at least one computer-readable medium of claim 1, wherein the configure the network interface device to utilize the second configuration for the VF based on the trigger event comprises:
reset the VF;
cause the network interface device to apply the second configuration for the VF; and
commence VF initialization.

5. The at least one computer-readable medium of claim 1, comprising instructions stored thereon, that if executed by the one or more processors, cause the one or more processors to:
execute the device driver to revert to the first configuration for the VF based on an error in the second configuration.

6. The at least one computer-readable medium of claim 1, wherein the network interface device driver is to access the network interface device in a manner consistent with Single Root I/O Virtualization (SR-IOV) or Scalable I/O Virtualization (SIOV).

7. A method comprising:
configuring packet transmission scheduling for a Network Interface Controller (NIC) Virtual Function (VF) by:
while the NIC applies a first transmission scheduling configuration, a NIC Physical Function (PF) device driver storing a second transmission scheduling configuration and
based on a trigger event, propagating the second transmission scheduling configuration to the NIC.

8. The method of claim 7, comprising:
based on the second transmission scheduling configuration being valid, the NIC applying the second transmission scheduling configuration.

9. The method of claim 7, wherein the trigger event comprises reset of the VF and wherein the PF driver performs the propagating the second transmission scheduling configuration to the NIC.

10. The method of claim 7, wherein the second transmission scheduling configuration comprises a packet transmission scheduling topology.

11. The method of claim 7, wherein the propagating the second transmission scheduling configuration to the NIC changes a packet transmission scheduling hierarchy.

12. The method of claim 7, comprising:
propagating a third transmission scheduling configuration to the NIC based on the third transmission scheduling configuration changing a weighting or shaping configuration of a leaf node or a tree node without a topology change to the second transmission scheduling configuration.

13. The method of claim 7, comprising:
based on the second transmission scheduling configuration being invalid or including an error, applying the first transmission scheduling configuration.

14. An apparatus comprising:
a network interface device comprising:
a direct memory access (DMA) circuitry;
a host interface;
a network interface; and
circuitry configured to:
apply a first packet transmission scheduling configuration for a virtual function (VF) and
based on a trigger event, apply a second packet transmission scheduling configuration.

15. The apparatus of claim 14, wherein the circuitry is to:
apply the second packet transmission scheduling configuration based on the trigger event and the second packet transmission scheduling configuration being valid.

16. The apparatus of claim 14, wherein the trigger event comprises reset of the VF.

17. The apparatus of claim 14, wherein the first and second packet transmission scheduling configurations comprise packet transmission scheduling topologies.

18. The apparatus of claim 14, wherein the circuitry is to:
adjust a scheduling or arbitration property of the first packet transmission scheduling configuration independent from occurrence of the trigger event.

19. The apparatus of claim 14, wherein the VF is consistent with Single Root I/O Virtualization (SR-IOV) or Scalable I/O Virtualization (SIOV).

20. The apparatus of claim 14, wherein the network interface device comprises one or more of: a network interface controller (NIC), a remote direct memory access (RDMA)-enabled NIC, SmartNIC, router, switch, virtual switch, forwarding element, infrastructure processing unit (IPU), data processing unit (DPU), or edge processing unit (EPU).
